(19) United States
(12) Patent Application Publication
(10) Pub. No.: US 2009/0300293 A1
(43) Pub. Date: Dec. 3, 2009

(54) Dynamically Partitionable Cache

(75) Inventors: Michael J. MANTOR, Orlando, FL (US); Brian A. Buchner, Oviedo, FL (US); John P. McCardle, II, Indialantic, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc., Sunnyvale, CA (US)

(21) Appl. No.: 12/165,741

(22) Filed: Jul. 1, 2008

Related U.S. Application Data
(60) Provisional application No. 61/057,452, filed on May 30, 2008.

(51) Int. Cl. G06F 12/08

(52) U.S. Cl. 711/141; 711/E12.026

(57) ABSTRACT

Methods and systems for dynamically partitioning a cache and maintaining cache coherency are provided. In an embodiment, a system for processing memory requests includes a cache and a cache controller configured to compare a memory address and a type of a received memory request to a memory address and a type, respectively, corresponding to a cache line of the cache to determine whether the memory request hits on the cache line. In another embodiment, a method for processing fetch memory requests includes receiving a memory request and determining if the memory request hits on a cache line of a cache by determining if a memory address and a type of the memory request match a memory address and a type, respectively, corresponding to a cache line of the cache.

### CROSS REFERENCE TO RELATED APPLICATIONS

This application claims the benefit of U.S. Provisional Appl. No. 61/057,452, filed May 30, 2008, which is incorporated by reference herein in its entirety.

### BACKGROUND OF THE INVENTION

1. Field of the Invention

The present invention relates to servicing memory requests. Specifically, the present invention relates to cache resource allocation and cache coherency.

2. Background Art

Memory requests solicit values held in a memory of a system. The requested values can be used in instructions executed by a processor unit. However, the time required to execute the memory request, the memory latency, can often hamper the operation of the processor unit. A cache can be used to decrease the average memory latency. The cache holds a subset of the memory that is likely to be requested by the processor unit. Memory lookup requests that can be serviced by the cache have shorter latency than memory lookup requests that require the memory to be accessed.

Multiple processing units can access the same cache. To prevent one processing unit from inadvertently accessing data intended for another processing unit, the cache can be partitioned. Specifically, a fixed partition can be used to separate the cache. However, the fixed partition can result in the cache being used inefficiently. For example, if the cache is heavily used by one processing unit and rarely used by another, portions of the cache will be under utilized.

Also, values held in the cache can become out-dated or stale when the corresponding value in the memory is changed. If stale data is provided in response to a memory request, the outcome of an instruction executed by the processing unit may be incorrect. To prevent stale data from being provided in response to a memory request, portions of the cache are invalidated when it is determined that they may have become stale according to one of many different cache coherency algorithms. However, such an invalidation process is often costly in terms of processing time.

Thus, what is needed is a system and method for dynamically partitioning a cache and efficiently maintaining cache coherence.

### BRIEF SUMMARY OF THE INVENTION

Embodiments described herein relate to methods and systems for dynamically partitioning a cache and maintaining cache coherency. A type is associated with portions of the cache. The cache can be dynamically partitioned based on the type. The type can also be used to identify portions of the cache that might have stale data. By using the type to identify possibly stale portions of the cache, invalidation can be done automatically by suitable inspection of the type of each portion of the cache.

In an embodiment, a system for processing fetch memory requests includes a cache and a cache controller configured to compare a memory address and a type of a received memory request to a memory address and a type, respectively, corresponding to a cache line of the cache to determine whether the memory request hits on the cache line.

In another embodiment, a method for processing fetch memory requests includes receiving a memory request and determining if the memory request hits on a cache line of a cache by determining if a memory address and a type of the memory request match a memory address and a type, respectively, corresponding to a cache line of the cache.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram illustration of a system for servicing memory requests.

FIG. 2 is a block diagram illustration of a system for servicing memory lookup requests, according to an embodiment of the present invention.

FIG. 3 is an exemplary diagram of a type field, according to an embodiment of the present invention.

FIG. 4 is a block diagram illustration of a system for servicing memory lookup requests, according to another embodiment of the present invention.

FIG. 5 is a flowchart of an exemplary method of servicing memory lookup requests, according to an embodiment of the present invention.

The present invention will be described with reference to the accompanying drawings. Generally, the drawing in which an element first appears is typically indicated by the leftmost digit(s) in the corresponding reference number.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

It would be apparent to one of skill in the art that the present invention, as described below, may be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

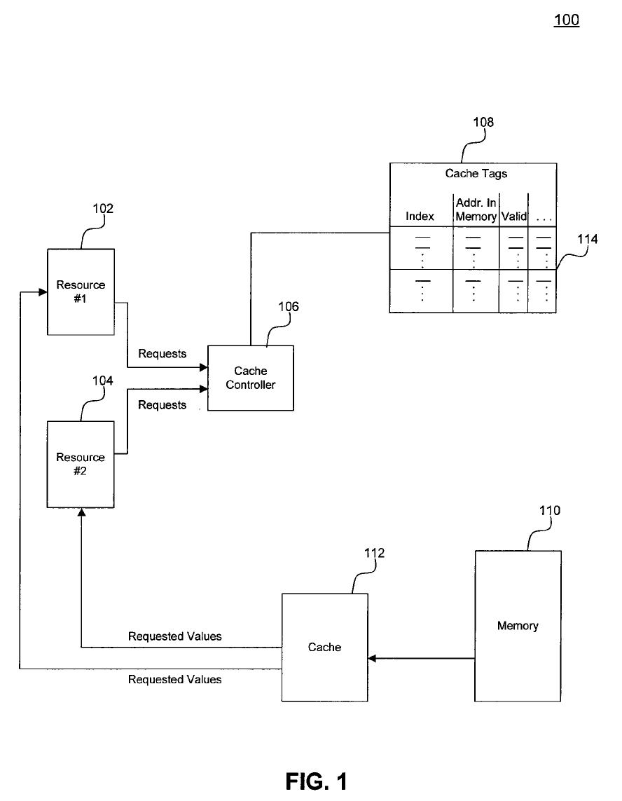

FIG. 1 is a block diagram illustration of a system 100 for servicing memory requests. System 100 includes a first resource 102, a second resource 104, a cache controller 106, a list of cache tags 108, a memory 110, and a cache 112. First and second resources 102 and 104 can be processor units such as a graphics processor unit (GPU). First resource 102 and/or second resource 104 can execute sets of instructions to perform a task, e.g., shaders used to perform rendering effects. These instructions can require values that are requested from memory 110.

Memory 110 can be the primary memory of system 100 and can be implemented as a random access memory (RAM). Since first and second resources 102 and 104 can typically execute instructions faster than memory requests can be serviced, the latency introduced by accessing memory 110 can hamper the performance of first and second resources 102 and 104.

To decrease the time required to service a memory request, cache 112 is provided. Cache 112 holds a subset of the values stored in memory 110. It is desired that cache 112 hold the subset of values of memory 110 that are most likely to be accessed by first and second resources 102 and 104. Because cache 112 is typically coupled to first and second resources 102 and 104 by a high speed path, the memory latency of memory requests serviced by cache 112 is shorter than the memory latency of requests serviced by memory 110.

Cache 112 includes a plurality of cache lines. Each of the cache lines is configured to hold a value stored in a memory 110. In alternate embodiments, each cache line of cache 112 can be configured to hold multiple values stored in memory 110. Cache 112 can be a multilevel cache. For example, cache 112 can include an L1 cache and an L2 cache. In an embodiment in which first resource 102 and/or second resource 104 is a GPU, cache 112 can hold graphics data. For example, cache 112 can be a vector or a texture cache.

Cache lines of cache 112 can become out-dated or stale if a value stored in memory 110 is changed and the corresponding cache line is not updated. Memory requests can be grouped into clauses formed such that cache 112 remains coherent with memory 110 within the clause. In particular, synchronization elements of system 100 (not shown) can be used to ensure that cache lines of cache 112 that are to be accessed in response to memory requests of a clause will not become stale as the clause is being serviced. However, this does not ensure that the cache lines of cache 112 will be coherent with memory 110, as the values stored in memory 110 corresponding to those cache lines may have been changed before the clause was serviced.

In an embodiment, a clause is defined as a contiguous burst of memory requests. In another embodiment, a clause can be defined as a group of instructions that will execute without interruption.

Cache controller 106 receives clauses of memory requests from first and second resources 102 and 104. Upon receiving a memory request, cache controller 106 determines if the memory request hits on a line cache line of cache 112. For a memory request to hit on a cache line of cache 112, the requested value must be resident in cache 112 and the cache line that includes the requested value must be valid.

In determining whether a memory request hits on a cache line of cache 112, cache controller 106 accesses a list of cache tags 108. Each row of list of cache tags 108 represents a tag that is associated with a cache line of cache 112. As shown in FIG. 1, each tag includes an index specifying the cache line, a field specifying the address(es) in memory 110 where the held value is located, and a valid flag that specifies whether the associated cache line is valid. In an embodiment, the valid field is a single bit, e.g., 1 for valid, and 0 for invalid. Each cache tag may also include a variety of other flags. For example, a flag may include the number of times the cache line has been accessed, a number of memory requests that are pending for the cache line, or other types of information that may be used to determine which cache line is selected when a new value from memory 110 must be written to cache 112. These flags can be updated as memory requests are serviced.

If the memory request does not hit on any of the cache lines of cache 112, the value is obtained from memory 110. The requested value replaces a value held in a cache line of cache 112. In determining which cache line of cache 112 can be used to hold the value obtained from memory 110, it is determined which cache lines of cache 112 are available. For example, cache controller 106 can access list of cache tags 108 to determine which cache lines do not have pending memory requests that have not been serviced. A variety of techniques known to those skilled in the relevant arts can be used to choose among the available cache lines to determine which one will have will hold the value obtained from memory 110. For example, cache controller 106 can use a first in first out (FIFO) or least recently used (LRU) technique along with the values stored in the flag fields of list cache tags 108 to determine which cache line is selected to have the value it is holding overwritten. Once the requested value is written into cache 112, the associated tag in list of cache tags 108 is updated, e.g., to include the memory address of the newly held value, to set the cache line as valid, and update the other fields. The requested value is provided from cache 112 to the requester (first resource 102 or second resource 104). In an alternate embodiment, the requested value can be provided directly from memory 110 to the requester.

As shown in FIG. 1, list of cache tags 108 includes a fixed partition 114. Fixed partition 114 effectively partitions cache 112 so that a portion of cache 112 is allocated to first resource 102 and another portion is allocated to second resource 104. In such a manner, first resource 102 does not inadvertently access values intended for second resource 104 and vice versa. However, fixed partition 114 also can result in a portion of cache 112 being under utilized. For example, if first resource 102 outputs a relatively low number of memory requests, its portion of cache 112 is more likely to include a substantial number of stale cache lines. If second resource 104 outputs a relatively high number of memory requests, its portion of cache 112 will have a relatively high number of valid cache lines over-written. Fixed partition 114 prevents part of the portion of cache 112 allocated to first resource 102 from being used to hold values for second resource 104 even if such a re-allocation would benefit second resource 104 and not hinder first resource 102.

Also, as described above, data held in cache 112 can become stale. If a cache line of cache 112 is determined to be stale, the cache line is invalidated. Invalidation occurs when the valid field of the associated tag in list of cache tags 108 is set to be invalid, for example, by setting the valid bit to 0. For example, a portion of cache controller 106, implemented in hardware, software, firmware, or a combination thereof can invalidate cache lines of cache 112 based on a range of addresses in memory 110 that have been updated. However, such an invalidation process is often costly in the number of cycles required to complete the invalidation.

### EXEMPLARY EMBODIMENTS

In embodiments described herein, methods and systems are provided that allow for dynamically partitioning a cache and efficiently maintaining cache coherence. Specifically, a tag associated with a cache line additionally includes a type field. In order for a memory request to hit on a line of a cache, the address requested by the memory request and its type must match the memory address field and tag field, respectively, of its associated tag and the cache line must be valid.

The additional type field can be used to dynamically allocate the resources of the cache and to efficiently maintain cache coherency. Different resources can each correspond to unique types. Since a cache hit requires matching a type of the request to the type of the cache line, the type effectively partitions the cache. The type field can also be used to identify portions of the cache that are to be automatically invalidated.

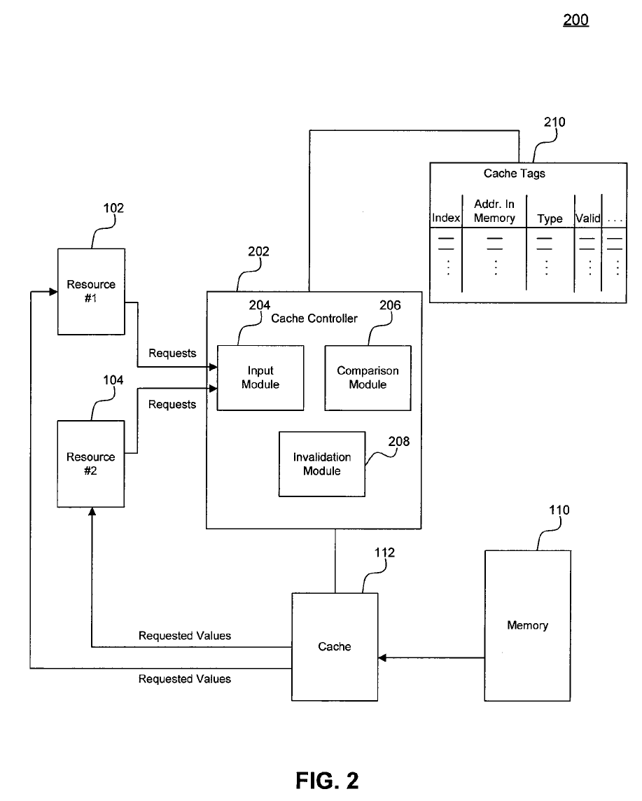

FIG. 2 is a block diagram illustration of a system 200 for servicing memory requests, according to an embodiment of the present invention. System 200 includes first and second resources 102 and 104, memory 110, cache 112, a cache controller 202, and a list of cache tags 210. First and second resources 102 and 104, memory 110, and cache 112 can be substantially similar to corresponding elements described with reference to FIG. 1.

Cache controller 202 receives clauses of memory requests from first and secondary resources 102 and 104. Cache controller 202 compares a requested memory address and the type of the memory request, to a memory address and a type corresponding to a cache line of cache 112. This comparison will determine if the memory request hits on the cache line.

Cache controller 202 includes an input module 204, a comparison module 206, and an invalidation module 208. Input module 204 extracts the requested memory address and the type from the received memory request. Comparison module 206 determines whether the memory request hits on a cache line of cache 112 based on the extracted memory address and type. Specifically, comparison module 206 compares the extracted memory address and type to the type and memory address fields of tags in list of cache tags 210. If the extracted memory address and type match corresponding fields of a tag of list of cache tags 210 and the associated cache line is determined to be valid, the memory request is determined to hit on that cache line. Invalidation module 208 is configured to invalidate one or more cache lines of cache 112. For example, the type field can be used to identify cache lines that are to be automatically invalidated.

List of cache tags 210 is substantially similar to list of cache tags 108 described with reference to FIG. 1, except that tags of list of cache tags 210 include an additional type field. The type field may be one or more bits. Thus, based on the type field of their associated tags, each cache line effectively has a type. The type of a cache line can be changed by changing the value of the type field in its associated tag.

Each cache line of cache 112 has a dynamically adjusted type. The type of a cache line is determined by the type field of the tag of list of cache tags 210 that is associated with that cache line.

Dynamic Allocation of Cache Resources

The type field can be used to allocate portions of cache 112. For example, each of first and second resources 102 and 104 can have unique types that are included in their respective memory requests. Since a hit on a cache line requires the type of the memory request to match the type of the cache line, first resource 102 is prevented from inadvertently accessing a cache line that includes data intended for second resource 104 and vice versa. As would be apparent to those skilled in the relevant arts, additional types can also be provided for additional resources that are coupled to cache controller 202.

The type field can also be used to partition the cache 112 based on the type of data that is held. For example, in graphics processing applications, the type field can be used to distinguish between pixel and vertex data. Partitioning cache 112 based on types of data can be done in addition to partitioning cache 112 based on individual resources.

Thus, first resource 102 can have different types of data held in cache 112. Each type of data is identified by its unique types. Each of these types associated with data intended for first resource 102 can be different than types used by second resource 104.

In the absence of a fixed partition that divides cache 112, the contents of cache 112 depend on memory requests received from first and second resources 102 and 104. Moreover, the type field of a tag of list of cache tags 210 associated with a cache line of cache 112 is updated when memory requests are received. In particular, the type the field is updated to be type of the received memory request. Thus, over time, the types of data in cache 112 (i.e., the values of the type fields of the tags associated with the cache lines) mimic received memory requests. For example, if first resource 102 generates more memory requests than second resource 104, cache 112 will tend to have proportionally more cache lines allocated to data for first resource 102 than for second resource 104. As the ratio of different types of memory requests changes, the ratio of cache lines allocated for each type adjusts accordingly. As would be appreciated by those skilled in the relevant arts, the same applies to types that differentiate between data types (e.g., between pixel and vertex data).

In another embodiment, the type of field can be used in addition to a fixed partition similar to partition 114 described with reference to FIG. 1. For example, the fixed partition can be used to divide cache 112 based on different resources while the type field can be used to partition cache 112 based on data types. As would be appreciated by those skilled in the art, other combinations of the type field and a fixed partition can be used without departing from the scope and spirit of the present invention.

Automatic Invalidation

In addition to being used to dynamically allocate cache 112 based resources or data types, the additional type field can be used to automatically invalidate cache lines of cache 112. As described above, synchronization elements can be used to ensure that a cache line does not become stale as a clause is being serviced. However, once the clause has been serviced, its continued freshness can no longer be guaranteed.

Based on the type field, cache lines of cache 112 can be designated for automatic invalidation. For example, when a clause has been serviced, invalidation module 208 inspects the type field of tags in list of cache tags 210 and invalidates all cache lines that are designated for automatic invalidation. Thus, instead of determining which cache lines should be invalidated based on a range of memory addresses in memory 110, cache lines can be invalidated based on the type field of their associated cache tag in list of cache tags 210. In such a manner, an invalidation process can be completed quickly compared to the multiple-cycle process required to invalidate cache lines based a range of addresses in memory 110. For example, type-based automatic invalidation can be done in one cycle.

In the illustration of FIG. 2, invalidation module 208 is completely implemented in hardware. Thus, cache lines of cache 112 can be automatically invalidated at specific points of operation without the intervention of software. In alternate embodiments, invalidation module 208 can be implemented as hardware, software, firmware, or a combination thereof.

In an embodiment, a single bit of the type field is used to designate a cache line for automatic invalidation, e.g., 1 for automatic invalidation and 0 for not automatic invalidation, or vice versa. Each cache line that is of the automatic invalidation type is invalidated by invalidation module 208 at end of the servicing of every received clause of memory requests. In a further embodiment, the entire type field is a single bit. In such an embodiment, the contents of cache 112 are dynamically allocated based on automatic invalidation, e.g., as opposed to resource or data types, as described above.

In alternate embodiments, multiple bits can be used to specify different types of automatic invalidation. For example, automatic invalidation can be associated with a type used to specify a resource or data type. For example, a type field may have two bits. The first bit can specify to which resource the cache line corresponds, e.g., 1 for first resource 102 and 0 for second resource 104. The second bit can specify whether the cache line is to be automatically invalidated, e.g., 1 for automatic invalidation and 0 for no automatic invalidation. Invalidation module 208 can invalidate all cache lines based solely on the second bit of the type field once all clauses are complete by invalidating all cache lines that have a 1 in the second bit position of their associated tag field. Alternatively, invalidation module 208 can automatically invalidate cache lines based on the type of the clause being serviced. For example, invalidation module 208 can invalidate all cache lines that have a 1 in their first bit position (corresponding to first resource 102) and a 1 in their second bit position (corresponding to automatic invalidation) when a clause of memory requests received from first resource 102 has been serviced.

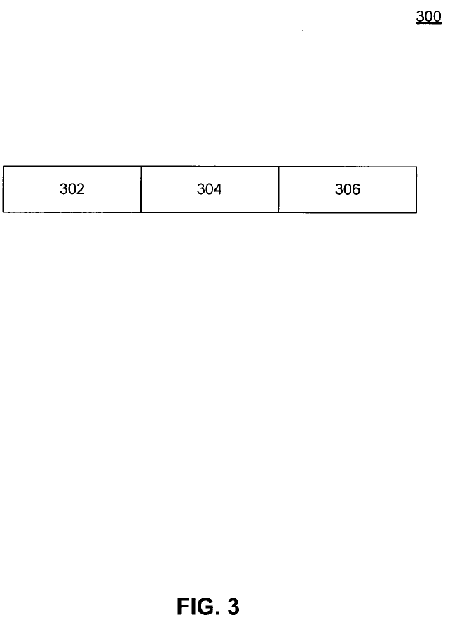

FIG. 3 is a diagram of exemplary type field 300, according to an embodiment of the present invention. Type field 300 includes portions 302, 304, and 306. Portion 302 can be used to identify different resources, e.g., different resources coupled to cache controller 202 such as first resource 102 and second resource 104. Portion 304 can be used to specify different types of data, e.g., texture data, vertex data, etc. Portion 306 can be used to designate the associated cache line for automatic invalidation. Each of portions 302, 304, and 306 can be one or more bits. As would be apparent to those skilled in the relevant arts, type field 300 is presented for illustration only and not intended to be limiting. Alternative type fields may include additional or fewer portions.

Although the embodiments described above have focused on systems with multiple resources, an additional type field can also be applied advantageously to a system that includes a single resource.

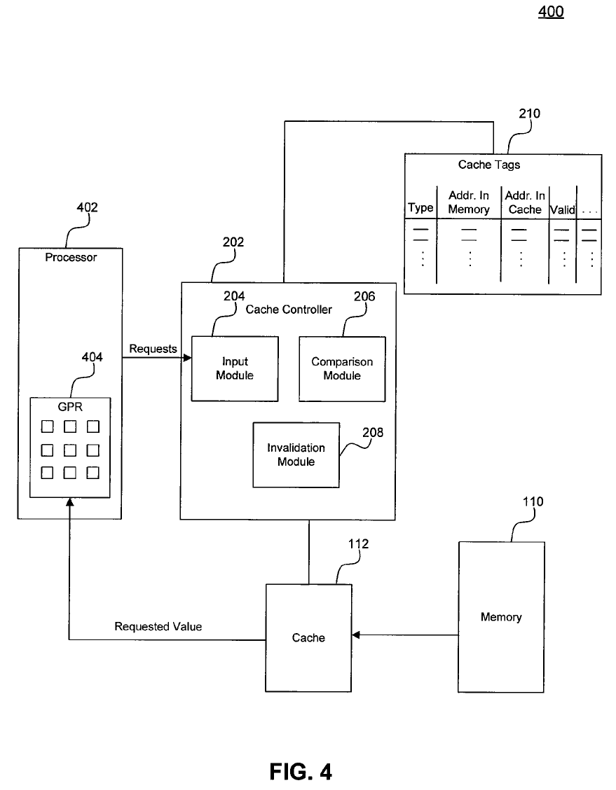

FIG. 4 is a block diagram illustration of a system 400 for servicing memory requests, according to an embodiment of the present invention. System 400 includes a processor 402, cache controller 202, list of cache tags 210, memory 110, and cache 112. The type field of tags associated with cache lines of cache 112 can be a single bit, e.g., a 1 indicating that the associated cache line is to be automatically invalidated and a 0 indicating that the associated cache line is not to be automatically invalidated.

Processor 402 can be a graphics processor or other type of processor. Invalidation module 208 can be configured to invalidate all cache lines of cache 112 that are designated for automatic invalidation when a clause has been serviced. Invalidation operations can be completed in a single cycle.

In another embodiment, cache lines of cache 112 that are designated for automatic invalidation can be invalidated when a clause has been suspended or serviced. Specifically, in systems that allow for one clause to preempt another clause, thereby suspending the first clause, cache 112 would be invalidated when the first clause is suspended. The automatic invalidation may result in some performance degradation due to redundant memory lookup requests required as a result of the automatic invalidation. For example, as clause is being serviced it can result in a set of values being added to cache 112. When the clause is suspended, all of the cache lines of cache 112 are invalidated. Then, once the clause is restarted, even if the set of values that were previously added remain coherent with corresponding values in memory 110, they still must be retrieved from memory 110 because the cache lines that are holding those values were invalidated as a result of the suspension.

The above described invalidation procedure can be used in a variety of applications. For example, automatic invalidation can be used in the processing of ring buffers. A ring buffer is a fixed sized buffer conceptually represented as a ring that allows data to be written to a fixed buffer and read out in a first in-first out (FIFO) order without having to shuffle elements within the ring buffer. Typically, a ring buffer has a producer/consumer relationship. The producer fills the buffer with data and the consumer reads data from the buffer.

For example, in the embodiment in which processor 402 is a graphics processor, a geometry shader can be the consumer. Values are written to the ring buffer, e.g., by a shader that writes data to the ring buffer such as an export shader, and the geometry shader can read values from the ring buffer in a FIFO order. The data can come from other shader stages or graphics hardware. The data can be a variety of different types of data, e.g., tessellation data. Once the geometry shader has completed reading the values of the ring buffer, the geometry shader can become a producer. The geometry shader then writes values to a second ring buffer and another shader (e.g., a vector shader) would be a consumer that reads those values.

Ring buffers can be used as links between different stages of a graphics processing pipeline. Once the consumer has completed reading the values of the ring buffer, a producer writes values to it. Thus, elements of a ring buffer are valid in cache only when the consumer is reading them. Automatic invalidation may be used when a consumer has completed reading data from a ring buffer. For example, when one or more clauses that make up the consumer have serviced, invalidation modules 208 automatically invalidates all cache lines that are designated for automatic invalidation.

Automatic invalidation can also be used to efficiently process the virtualization of general purpose registers. As shown in FIG. 3, processor 402 includes general purpose registers (GPR) 404. In an embodiment, GPRs 404 can be used to implement scratch memory. In the embodiment in which processor 402 is a graphics processor, scratch memory can be used as temporary storage for different shaders. Because scratch memory is made up of general purpose registers that are expensive in terms of space on processor 402, they may be virtualized using memory 110. In particular, the values of certain general purpose registers of GPR 404 can be sent to a ring buffer implemented in memory 110 and read back to GPR 404 when they are required.

Thus, processor 404 can operate as if it has more GPRs that it actually has. In order to avoid having to access memory 110 to retrieve a value to be placed in a GPR of GPRs 404, the value may be retrieved from cache 112. When a clause that includes memory requests that reads the data in the ring buffer has been serviced, cache lines that hold values of that ring buffer can be automatically invalidated by invalidation module 208.

Automatic invalidation can be particularly useful in situations where it is known that a value will likely not be read after a clause has been serviced. For example, in the case of a ring buffer with a producer/consumer relationship, it is known that values of the ring buffer will probably not be accessed after the consumer has read them. Thus, automatic invalidation will probably not lead to erroneous cache misses, i.e., cache misses because a cache line was invalid when it actually did include fresh data.

Although system 400 is shown as including a single resource (e.g., processor 402), those skilled in the art will appreciate that it can include multiple resources without departing from the scope and spirit of the present invention. In embodiments in which system 300 includes multiple resources, the type can be larger than a single bit.

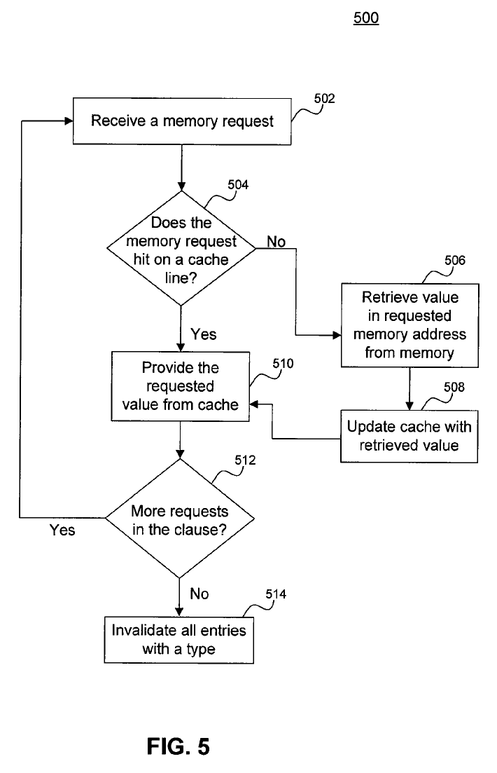

FIG. 5 is a flowchart of an exemplary method 500 of providing example steps for servicing memory requests, according to the present invention. Other structural and operational embodiments will be apparent to persons skilled in the relevant art(s) based on the following discussion. Flowchart 500 is described with reference to the embodiment of FIG. 2. However, flowchart 500 is not limited to that embodiment. The steps shown in FIG. 5 do not necessarily have to occur in the order shown. The steps of FIG. 5 are described in detail below.

In step 502, a memory request is received. For example, in FIG. 2, a memory request is received by cache controller 202 from first resource 102 or second resource. In an embodiment, the received memory request is a member of a clause of memory requests.

In step 504, it is determined whether the memory request hits on a cache line. For example, comparison module 206 of cache controller 202 determines whether the received memory request hits on a cache line of cache 112. Specifically, comparison module 206 determines if the type and address fields of tags associated with cache lines of cache 112 match the memory address and the type of memory request, respectively, and analyzes the valid fields of the tags to determine if their associated cache lines are valid.

If the memory request does not hit on any cache line step 506 is reached. In step 506, the requested value is retrieved from memory. For example, in FIG. 2, the requested value is retrieved from memory 110.

In step 508, the cache is updated with the retrieved value. For example, in FIG. 2, a cache line of cache 112 is selected to have its data overwritten by the value retrieved from memory 110. As described above, the selected cache line can be a cache line of cache 112 that is available and chosen by a variety of cache replacement algorithms.

The tag associated with the cache line is updated when the memory request is received. Thus, the associated tag can be updated before the cache line has its value overwritten with the retrieved value.

In step 510, the value is provided from cache. For example, in FIG. 2, the requested value is provided to the requester (e.g., first resource 102 or second resource 104) by cache 112.

In step 512, it is determined whether there are more request in the clause. If there are more requests in the clause, flowchart 500 returns to step 502 and the next memory request in the clause is processed. If the received memory request is the last memory request of the clause, step 514 occurs. In step 514 all entries with a predetermined type are invalidated. For example, in FIG. 2, invalidation module 208 can invalidate all cache lines of cache 112 that have the type of the received memory request. In alternative embodiments, invalidation module 208 invalidates other types of cache lines.

Embodiments of the present invention may be used in any computing device where register resources are to be managed among a plurality of concurrently executing processes. For example and without limitation, embodiments may include computers, game platforms, entertainment platforms, personal digital assistants, and video platforms. Embodiments of the present invention may be encoded in many programming languages including hardware description languages (HDL), assembly language, and C language. For example, an HDL, e.g., Verilog, can be used to synthesize, simulate, and manufacture a device that implements the aspects of one or more embodiments of the present invention. For example, Verilog can be used to model, design, verify, and/or implement cache controller 202, described with reference to FIG. 2.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for processing memory requests, comprising:
a cache;
a cache controller configured to compare a memory address and a type of a received memory request to a memory address and a type, respectively, corresponding to a cache line of the cache to determine whether the memory request hits on the cache line.

2. The system of claim 1, wherein the cache controller is configured to provide a value held in the cache line if the memory request hits on the cache line.

3. The system of claim 1, wherein the first memory request is received from a first resource, wherein the cache controller is configured to receive a second memory request from a second resource, and wherein a type of the second memory request is different than the type of the first memory request.

4. The system of claim 1, wherein the cache controller comprises:
a comparison module configured to compare the type of the memory request to the type corresponding to the cache line.

5. The system of claim 1, wherein the cache controller comprises:
an input module configured to receive the memory request and extract the type and the memory address of the memory request from the memory request.

6. The system of claim 1, wherein the cache controller is configured to replace a value held in an available cache line with a value corresponding to the memory address of the memory request if the memory request does not hit on any cache line of the cache and wherein the cache controller is configured to update a memory address and a type of a tag associated with the available cache line to include the memory address and the type, respectively, of the memory request.

7. The system of claim 1, wherein the memory request is included in a clause of memory requests, wherein each memory request of the clause of memory requests has the same type, and wherein the cache controller is configured to invalidate a second cache line of the cache that has a corresponding type that matches the type of the memory request.

8. The system of claim 7, wherein the cache controller is configured to invalidate all cache lines of the cache that have a corresponding type that matches the type of the memory request if the memory request is the last memory request of the clause.

9. The system of claim 7, wherein the type of the memory request is specified by a one-bit field.

10. The system of claim 7, wherein the cache controller module is configured to compare the memory address and the type of the memory request to the memory address and the type corresponding to the cache line in a clock cycle.

11. The system of claim 10, wherein the cache controller is configured to invalidate the second cache line in the clock cycle.

12. The system of claim 1, wherein the memory address of the memory request corresponds to a scratch register or an entry in a ring buffer.

13. A method for processing memory requests, comprising:
receiving a memory request; and
determining if the memory request hits on a cache line of a cache by determining if a memory address and a type of the memory request match a memory address and a type, respectively, corresponding to a cache line of the cache.

14. The method of claim 13, further comprising:
providing a value held in the cache line in response to the memory request if the memory request hits on the cache line.

15. The method of claim 13, wherein the determining step further comprises:
determining if the cache line is valid.

16. The method of claim 13, further comprising:
receiving a second memory request;
wherein the first memory request is received from a first resource and the second memory request is received from a second resource and wherein the type of the first memory request is different than a type of the second memory request.

17. The method of claim 13, further comprising:
replacing a value held in a second cache line of the cache with a value corresponding to the memory address of the memory request if the memory request does not hit on any cache line of the cache; and
updating a memory address and a type of a tag associated with the second cache line to include the memory address and the type, respectively, of the memory request.

18. The method of claim 13, wherein the memory request is included in a clause of memory requests and wherein each memory request of the clause of memory requests has the same type, further comprising:
invalidating a second cache line of the cache that has a corresponding type that matches the type of the memory request.

19. The system of claim 18, wherein the invalidating step further comprises:
invalidating all cache lines of the cache that have a corresponding type that matches the type of the memory request if the memory request is the final memory request of the clause.

20. A computer readable medium carrying one or more sequences of one or more instructions for execution by one or more processors to perform a method for processing memory requests, the instructions when executed by the one or more processors, cause the one or more processors to:
(a) receive a memory request; and
(b) determine if the memory request hits on a cache line of a cache by determining if a memory address and a type of the memory request match a memory address and a type, respectively, corresponding to a cache line of the cache.

21. The computer readable medium of claim 20, wherein the sequences of instructions are encoded using a hardware description language (HDL).
